(19) United States
(12) Patent Application Publication
(10) Pub. No.: US 2018/0135411 A1
(43) Pub. Date: May 17, 2018

(54) Corrosion Resistant Expandable Bolt

(71) Applicant: FCI Holdings Delaware, Inc., Wilmington, DE (US)

(72) Inventors: John C. Stankus, Canonsburg, PA (US); Dakota Faulkner, New Kensington, PA (US); Kevin Jinrong Ma, Cheswick, PA (US); David Rager, McKeesport, PA (US)

(21) Appl. No.: 15/810,599

(22) Filed: Nov. 13, 2017

Related U.S. Application Data
(60) Provisional application No. 62/423,225, filed on Nov. 17, 2016.

(51) Int. Cl. E21D 21/00; B21D 15/02; B05D 7/00

(52) U.S. Cl. CPC E21D 21/0073; B05D 7/52; B21D 15/02; E21D 21/004

(57) ABSTRACT

Rock bolts comprising an expandable tube having a longitudinally extending depression disposed between two curved outer portions of the tube, wherein the depression defines a channel having an opening defined between the two curved outer portions of the tube and the width of the opening is at least 10% of the width of the tube and/or a coating layer covers at least a portion of the expandable tube. Also, a method of manufacturing a rock bolt comprising forming an expandable tube comprising a longitudinally extending depression disposed between two curved outer portions of the tube, crimping a proximal end of the tube to form a crimped portion, and placing a sleeve around the crimped portion. Prior to crimping, a temporary spacer is placed in the channel in a portion of the tube adjacent to the portion of the tube that will be crimped.

### CROSS-REFERENCE TO RELATED APPLICATION

This application claims priority to U.S. Provisional Application Ser. No. 62/423,225, filed Nov. 17, 2016, which is hereby incorporated by reference in its entirety.

### BACKGROUND OF THE INVENTION

### Field of the Invention

This invention relates to a rock bolt having an expandable tube and a method of making such a rock bolt.

### Description of Related Art

Rock bolts are used in underground mines, such as coal mines, to support the roof and ribs. Installation of conventional rock bolts involves drilling a borehole into the rock to a desired depth using an elongated drilling tool (termed the drill steel), removing the drill steel from the borehole, optionally inserting adhesive resin cartridges, and retaining the cartridges in the blind end of the borehole while a bolt, optionally bearing an expansion anchor, is installed into the borehole. The free end of the bolt extending out of the borehole is received by a chuck of a bolting machine. The bolting machine rotates the bolt within the borehole to mix the adhesive resin and/or expand the expansion anchor.

Other rock bolts comprise a longitudinally expandable tube that includes a longitudinally extending depression between two curved outer portions where the tube is partially collapsed on itself. The distal end of the tube is folded over to create two enclosed cavities in the curved outer portions of the tube while a temporary passageway defined by the depression remains open at both ends. After placing the rock bolt in the pre-drilled borehole, pressurized fluid is delivered into the two cavities to force the depression outward, expand the tube, and compress it against the surrounding rock. Such rock bolts are made of steel and other materials that may not be corrosion resistant. Corrosion in the rock bolt can cause the integrity of the rock bolt in the mine roof to be compromised.

### SUMMARY OF THE INVENTION

The present invention is directed to a rock bolt comprising an expandable tube having a longitudinally extending depression disposed between two curved outer portions of the tube, wherein the depression defines a channel having an opening defined between the two curved outer portions of the tube and the width of the opening is at least 10% of the width of the tube. The width of the opening may be 30-60% of a width of the channel. The rock bolt may be at least partially coated with a coating layer that may comprise polyurethane.

The rock bolt may further comprise a distal sleeve positioned on a distal end of the tube and/or a cover that covers at least one open end of the channel. The distal sleeve may be provided with an opening that corresponds to an opening in the tube.

The present invention is also directed to a method of manufacturing a rock bolt. An expandable tube comprising a longitudinally extending depression disposed between two curved outer portions of the tube and an interior passageway defined by an interior surface of the tube is formed. The depression defines a channel having an opening defined between the two curved outer portions of the tube. The proximal end of the expandable tube is crimped to form a crimped portion having a reduced diameter and a sleeve is placed around the crimped portion of the proximal end of the tube. Prior to crimping the proximal end of the tube, a temporary spacer is placed in the channel in a portion of the tube adjacent to a portion of the tube that will be crimped.

The method may further comprise welding the sleeve to the tube such that the interior passageway is closed by the weld and/or applying a coating layer to at least a portion of the rock bolt. The coating layer may comprise polyurethane. A second coating layer may be applied to at least a portion of the rock bolt.

The width of the opening may be at least 10% of the width of the tube and/or 30-60% of a width of the channel.

The present invention is directed to a rock bolt comprising an expandable tube having a longitudinally extending depression disposed between two curved outer portions of the tube and a coating layer covering at least a portion of the expandable tube. The coating layer may comprise polyurethane. The width of the opening may be at least 10% of the width of the tube and/or 30-60% of the width of the channel. The rock bolt may further comprise a cover that covers an open end of the channel.

### BRIEF DESCRIPTION OF THE DRAWINGS

FIG. 1 is a side view of a rock bolt produced according to the present invention;

FIG. 2 is a cross-section taken along lines A-A of FIG. 1;

FIG. 3 is a cross-section taken along lines B-B of FIG. 1 prior to the sleeve being welded to the expandable tube;

FIG. 4 is a proximal end view of the rock bolt of FIG. 1 showing the sleeve welded to the expandable tube prior to the attachment of the cover;

FIG. 5 is a cross-section taken along lines A-A of FIG. 1, as installed and expanded in rock strata;

FIG. 6 is a cross-sectional view of an exemplary roll-forming progression for the expandable tube of the present invention;

FIG. 7 is a side view of an end of the inventive expandable tube after crimping;

FIG. 8 is a side view of an end of the inventive expandable tube after placement of one of the sleeves;

FIG. 9A shows a cross-sectional profile of a prior art expandable tube having an insufficient opening to the channel; and

FIG. 9B shows a cross-sectional profile of an inventive expandable tube.

### DESCRIPTION OF THE INVENTION

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1. Plural encompasses singular and vice versa. When ranges are given, any endpoints of those ranges and/or numbers within those ranges can be combined with the scope of the present invention. “Including”, “such as”, “for example” and like terms means “including/such as/for example but not limited to”.

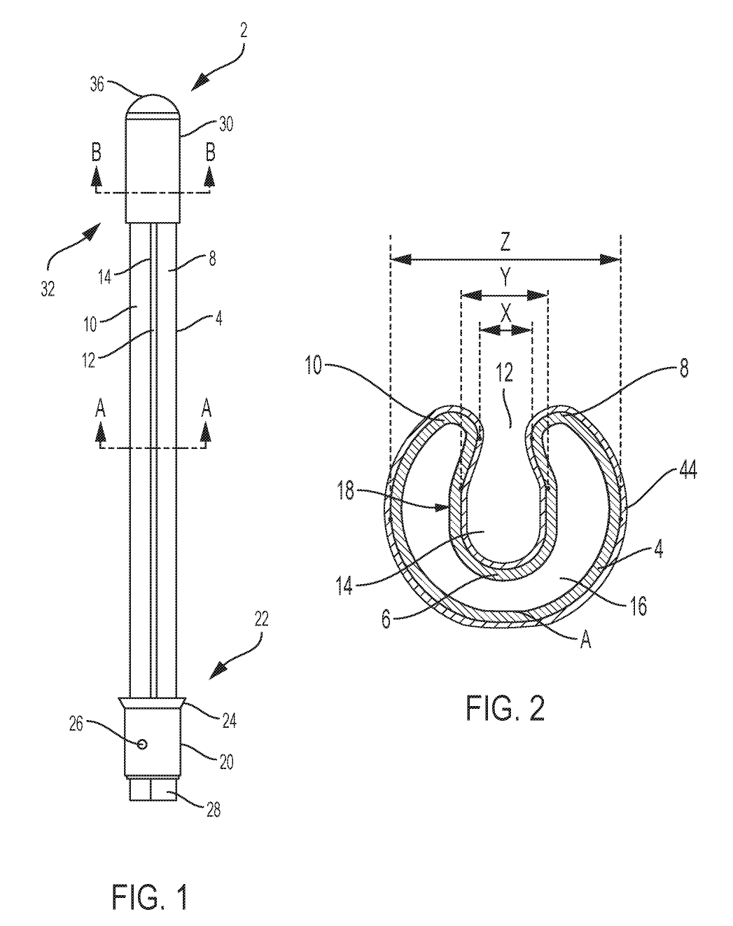

Referring to the drawing figures in which like reference numbers refer to like elements, FIG. 1 shows a rock bolt 2 according to the present invention. The rock bolt 2 includes an expandable tube 4 having an initial cross-sectional profile as shown in FIG. 2. The tube 4 is partially collapsed upon itself so as to provide a depressed region 6 defined by two curved outer portions 8, 9 extending longitudinally along the tube 4. The curved outer portions 8, 10 are spaced apart from one another providing an opening 12 into a channel 14 defined by the outer surface of the depressed region 6 of the expandable tube 4. The opening 12 may have a width X that is 30-60% of the maximum width Y of the channel 14, for example, 35-60% or 40-50% of the maximum width Y of the channel 14, and at least 10% of the width Z of the expandable tube 4, for example, at least 15% or at least 20% of the width Z of the expandable tube 4. The channel 14 may have a maximum width Y that is 35-60% of the width Z of the expandable tube 4, for example, 35-50% or 35-45% the width Z of the expandable tube 4. For example, the rock bolt 2 may have a width X of the opening 12 that is 6.3 mm, the channel 14 may have a maximum width Y of 5-7 mm, for example, 5.5-6.9 mm or 5.85-6.85 mm, and the expandable tube 4 may have a width Z of 20-35 mm, for example, 25-30 mm or 27-28 mm.

An interior passageway 16 is defined by the inner surface 18 of the expandable tube 4. While the interior passageway 16 is shown in FIG. 2 to comprise a single continuous passageway, the inner surface 18 of the expandable tube 4 may contact itself at the bottom portion of the depressed region 6, as at A, thereby creating two separate interior passageways.

The expandable tube 4 may be produced from a steel alloy or the like having sufficient strength to function in rock support, even after deformation from internal hydraulic pressure as described below.

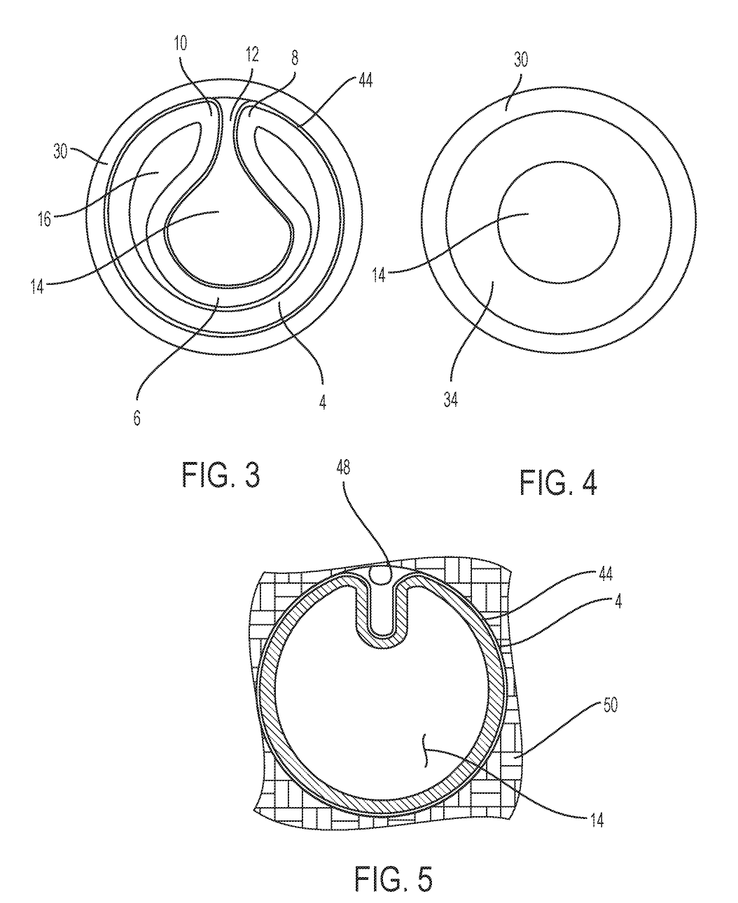

A sleeve 20, having a sidewall and two open ends, is attached to and surrounds a distal end 22 of the expandable tube 4 (FIG. 3). A lip 24 may extend from the sleeve 20 for engaging with a rock surface when the rock bolt 2 is inserted into a borehole. The sleeve 20 has an opening 26 which is aligned with an opening (not shown) in the expandable tube 4, such that the openings are in fluid communication with the interior passageway 16. A drive nut 28 is attached to the distal end 22 of the expandable tube 4.

A sleeve 30, having a sidewall and two open ends, is attached to and surrounds a proximal end 32 of the expandable tube 4 leaving the end of the expandable tube 4 uncovered.

Both the sleeve 20 and the sleeve 30 are welded to the expandable tube 4. The weld 34, which may be one or more welds, extends over and closes the ends of the interior passageway 16 of the expandable tube 4 while leaving the channel 14 open (FIG. 4).

A cover 36, such as a spherical member, may, optionally, be provided to cover the open proximal end of the channel 14 and may be fixed thereto by welding or the like. Such covers are described in U.S. Pat. No. 9,062,547, incorporated herein by reference.

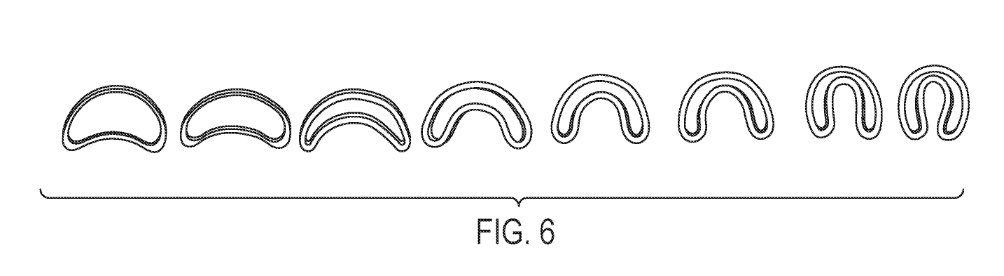

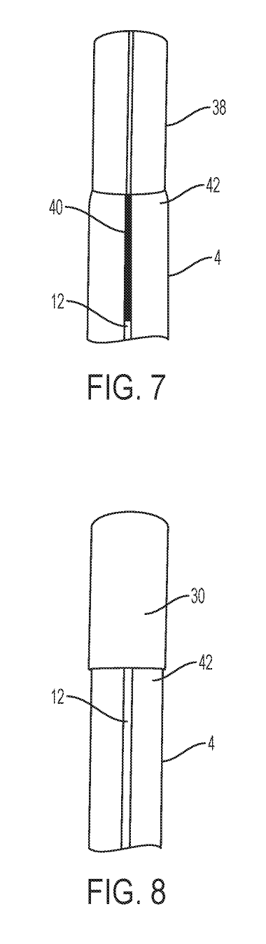

During manufacture, the profile of the expandable tube 4 may be created by roll-forming a substantially cylindrical tube. The roll-forming may be completed in a progression of steps as shown in FIG. 6. After the profile of the expandable tube 4 has been established, a portion 38 of at least one of the ends 22, 32 of the expandable tube 4 are crimped to slightly reduce the outside diameter of the expandable tube 4 (FIG. 7). This crimping process also reduces the width X of the opening 12 in the crimped portion 38 (see FIG. 3). During this crimping process, a temporary spacer 40, such as a metal block, is inserted in the opening 12 of the channel 14 in the area 42 adjacent to the portion 38 of the expandable tube 4 that is being crimped (FIG. 7). Spacer 40 minimizes or prevents the opening 12 to the channel 14 in the area 42 adjacent the crimped portion 38 from being narrowed during the crimping process. The sleeve 20 and the sleeve 30 are then placed over the distal end 22 and the proximal end 32 of the expandable tube 4 (FIG. 8). A circumferential weld may be used to attach at least one of the sleeves 20, 30 to the expandable tube 4 and to close the ends of the interior passageway 16 (FIG. 4). The opening 26 is then drilled through the sleeve 20 and the expandable tube 4 such that the opening 26 is in fluid communication with the interior passageway 16 of the expandable tube 4. Alternatively, openings may be defined in the sleeve 20 and the expandable tube 4 prior to assembly. The drive nut 28 is attached to the distal end 22 of the expandable tube 4.

At least a portion of the exterior surface of the expandable tube 4 may be covered with at least one coating layer 44 to provide corrosion and abrasion resistance. The coating layer 44 may comprise thermoplastic, thermoset plastic, epoxy, polyurea, polyurethane, and/or combinations thereof and may have a thickness of 145-260 μm, for example, 150-255 μm or 152-254 μm. The coating may be applied in more than one layer. The layers may comprise the same coating composition or different coating compositions. To provide protection against corrosion, abrasion, and physical scratch damage, a flexible, adhesive, and highly corrosion-resistant undercoat using a first coating composition and a hard sacrificial topcoat comprising one or more layers of at least one other coating composition(s) may be applied to the expandable tube 4. Each layer may be applied using any suitable method including, but not limited to, powder coating and liquid spray coating. The coating layer 44 may be applied to the expandable tube 4 after the formation of the channel 14 and prior to assembly with the sleeves 20, 30, the drive nut 28, and the optional cover 36. Alternatively, the coating layer 44 may be applied to the entire rock bolt 2 after it has been fully assembled. For example, a two-component polyurethane coating composition (polyol and polyisocyanate components) provided in powder form may be spray applied to the rock bolt 2 and cured by heating so that the resulting polyurethane polymer forms a smooth coating over the exterior surface of the rock bolt 2. The spraying process may involve applying two layers of a two-component polyurethane coating composition and curing the two layers sequentially or simultaneously. Alternatively, a first layer having a first coating composition may be applied followed by one or more layers having the same or different coating compositions and the layers may be cured sequentially or simultaneously. The coating layers may be colored by including a pigment, such as carbon black, in the coating composition to create a coating layer having a color that is visibly different from the color of the underlying steel. For example, the color of the coating layer 44 may be darker than the underlying steel. In this manner, the rock bolt 2 may be inspected for damage to and/or lack of integrity of the coating layer 44 prior to installation by checking for any regions missing the differently colored coating layer 44. Including more than one layer of the coating further enhances corrosion protection of the rock bolt 2. Upon insertion into the borehole, the surrounding rough rock strata 50 may scrape against the rock bolt 2 and damage the coating layer 44 and potentially the underlying steel. By including at least one additional coating layer, the underlying steel is protected from such potential damage.

Any suitable pretreatment may be used prior to applying the coating including, but not limited to, sand blasting and/or chemical degreasing.

In addition, the at least one coating layer is able to flex along with the underlying expandable tube 4 and remain adhered thereto without cracking or peeling. Sufficient adhesion properties of the coating layer may be achieved by applying a plurality of layers to thickness (as opposed to one thick layer), pretreating the rock bolt 2 surface as described above, and/or using a coating composition that remains flexible after curing.

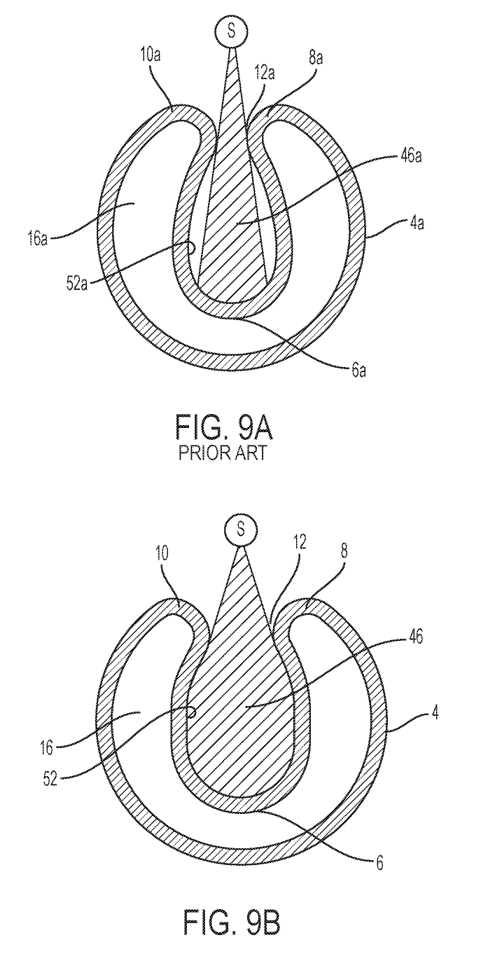

The profile of the expandable tube 4, including the width X of the opening 12 and the dimensions of the channel 14 provide exposure to the surface of the expandable tube 4 in the depressed region 6 for coating thereof. FIGS. 9A and 9B show regions 46a and 46, respectively, that correspond to the region accessible via a source S of pretreatment (e.g., sandblasting) and coating (e.g., powder coating). FIG. 9A shows a prior art expandable tube 4a having an opening 12a that is not sufficient to allow access to the depressed region 6a for pretreatment and/or coating of the outer surface 52a of the expandable tube 4a. FIG. 9B shows an inventive expandable tube 4 having an opening 12 that is sufficient to allow access to the depressed region 6 for pretreatment and/or coating of the interior surface of the expandable tube 4. The region 46 of the expandable tube 4 of the present invention is larger than the region 46a of the prior art expandable tube 4a, such that a larger area of the outer surface 52 of the depressed region 6 is accessible for pretreatment and/or coating thereof as compared to the prior art expandable tube 4a. The improved coverage of the pretreatment and the coating on the surface of the expandable tube 4 in the depressed region 6 helps to assure that the depressed region 6 of the expandable tube 4 will have good coating adhesion even after expansion. The provision of the opening 12 along the entire length of the channel 14 from the proximal edge of the sleeve 20 to the distal edge of the sleeve 30 allows for sufficient cleaning and good coating adhesion of the surface of the expandable tube 4 along the entire length of the channel 14. In this manner, adhesion of the coating upon expansion in the portion of the expandable tube 4 corresponding to the depressed region 6 can be improved or maximized as compared to prior art expandable bolts.

Additionally, the profile of the expandable tube 4, including the width X of the opening 12 and the dimensions of the channel 14, allow for faster expansion of the expandable tube 4 versus prior art rock bolts having a closed or substantially closed profile. For example, under the same installation conditions, a prior art rock bolt having an expandable tube 4a with the profile shown in FIG. 9A will take 5-10 seconds to fully expand where the inventive rock bolt having an expandable tube 4 with the profile shown in FIG. 9B will only take 3-5 seconds to fully expand.

In operation, a borehole 48 is drilled into the rock to the desired depth and the rock bolt 2 is inserted through a bearing plate and into the borehole 48. A source of pressurized fluid, such as water, is delivered through the opening 26 of the sleeve 20 and the opening in the expandable tube 4 and into the interior passageway 16. When the interior passageway 16 is filled, the further addition of fluid creates sufficient hydraulic pressure to expand the expandable tube 4, forcing the depressed region 6 outward toward the interior of the borehole 48 and ultimately compressing the tube 4 against the surrounding rock 50 of the borehole 48 (FIG. 5). When the tube 4 is fully expanded and no further fluid is received therein, the fluid supply is removed and the fluid is drained. In this manner, the expandable tube 4 frictionally anchors into and/or against the surrounding rock 50.

Whereas particular aspects of this invention have been described above for purposes of illustration, it will be evident to those skilled in the art that numerous variations of the details of the present invention may be made without departing from the invention as defined in the appended claims.

The invention claimed is:

1. A rock bolt comprising:
an expandable tube having a longitudinally extending depression disposed between two curved outer portions of the tube,
wherein the depression defines a channel having an opening defined between the two curved outer portions of the tube, and
wherein a width of the opening is at least 10% of a width of the tube.

2. The rock bolt of claim 1, wherein the rock bolt is at least partially coated with at least one coating layer.

3. The rock bolt of claim 1, wherein the at least one coating layer comprises thermoplastic, thermoset plastic, epoxy, polyurea, and/or polyurethane.

4. The rock bolt of claim 2, wherein the rock bolt is at least partially coated with a first flexible coating layer and a second abrasion resistant coating layer.

5. The rock bolt of claim 1, wherein the rock bolt is at least partially coated with a first coating layer having a first coating composition and at least one additional coating layer having a second coating composition, the first coating composition being different from the second coating composition.

6. The rock bolt of claim 1, wherein a width of the opening is 30-60% of a width of the channel.

7. The rock bolt of claim 1, further comprising a distal sleeve positioned on a distal end of the tube.

8. A method of manufacturing a rock bolt comprising:
forming an expandable tube comprising:
a longitudinally extending depression disposed between two curved outer portions of the tube; and
an interior passageway defined by an interior surface of the tube,
wherein the depression defines a channel having an opening defined between the two curved outer portions of the tube;
crimping a proximal end of the expandable tube to form a crimped portion having a reduced diameter; and
placing a sleeve around the crimped portion of the proximal end of the tube,
wherein, prior to crimping the proximal end of the tube, a temporary spacer is placed in the channel in a portion of the tube adjacent to a portion of the tube that will be crimped.

9. The method of claim 8, further comprising welding the sleeve to the tube such that the interior passageway is closed by the weld.

10. The method of claim 8, further comprising applying a coating layer to at least a portion of the rock bolt.

11. The method of claim 10, wherein the coating layer comprises thermoplastic, thermoset plastic, epoxy, polyurea, and/or polyurethane.

12. The method of claim 10, further comprising applying at least one additional coating layer to at least a portion of the rock bolt.

13. The rock bolt of claim 12, wherein the coating layer has a first coating composition and the at least one additional coating layer has a second coating composition, the first coating composition being different from the second coating composition.

14. The method of claim 8, wherein a width of the opening is at least 10% of the width of the tube.

15. The method of claim 8, wherein a width of the opening is 30-60% of a width of the channel.

16. A rock bolt comprising:
an expandable tube having a longitudinally extending depression defining a channel disposed between two curved outer portions of the tube, wherein an opening into the channel is provided between the two curved outer portions of the tube; and
at least one coating layer covering at least a portion of the expandable tube.

17. The rock bolt of claim 16, wherein the at least one coating layer comprises thermoplastic, thermoset plastic, epoxy, polyurea, and/or polyurethane.

18. The rock bolt of claim 16, further comprising a first coating layer having a first coating composition and at least one additional coating layer having a second coating composition, the first coating composition being different from the second coating composition.

19. The rock bolt of claim 16, wherein the width of the opening is at least 10% of the width of the tube.

20. The rock bolt of claim 16, wherein a width of the opening is 30-60% of a width of the channel.
